(19) United States
(12) Patent Application Publication
(10) Pub. No.: US 2024/0079607 A1
(43) Pub. Date: Mar. 7, 2024

(54) Fuel Cell Gas Diffusion Layers

(71) Applicant: Robert Bosch GmbH, Stuttgart (DE)

(72) Inventors: Lei Cheng, San Jose, CA (US); Xiaobai Li, Cupertino, CA (US); Christina Johnston, San Jose, CA (US); Bicheng Chen, Jiangsu (CN); Rikiya Yoshida, Tokyo (JP); Shinichi Makino, Yokohama-shi (JP); Xu Zhang, Jiangsu (CN); John F. Christensen, Elk Grove, CA (US)

(21) Appl. No.: 18/262,240

(22) PCT Filed: Jan. 22, 2021
(86) PCT No.: PCT/US2021/014624

§ 371 Date: Jul. 20, 2023

(51) Int. Cl. H01M 8/0234; H01M 8/0243; H01M 8/0258

(52) U.S. Cl. CPC H01M 8/0234; H01M 8/0243; H01M 8/0258; H01M 2008/1095

(57) ABSTRACT

A fuel cell includes a gas diffusion layer (GM) situated between a catalyst layer of the fuel cell and a flow field plate of the fuel cell. The GM has a first region and a second region along a thickness direction of the fuel cell. The first region is adjacent to the catalyst layer and has a first thermal conductivity. The second region is adjacent to the flow field plate and has a second thermal conductivity lower than the first thermal conductivity.

### TECHNICAL FIELD

The present disclosure relates to fuel cell gas diffusion layers (GDLs), for example, GDLs for a proton exchange membrane (PEM) fuel cell.

### BACKGROUND

Fuel cells have shown promise as an alternative power source for vehicles and other transportation applications. Fuel cells operate with a renewable energy carrier, such as hydrogen. Fuel cells also operate without generating toxic and greenhouse gases. GDLs are important components in a PEM fuel cell stack, which not only diffuse reactants from flow field plates to catalyst layers but also facilitates heat and water removal in the PEM fuel cell.

### SUMMARY

According to one embodiment, a fuel cell is disclosed. The fuel cell may include a gas diffusion layer (GDL) situated between a catalyst layer of the fuel cell and a flow field plate of the fuel cell. The GDL may have a first region and a second region along a thickness direction of the fuel cell. The first region may be adjacent to the catalyst layer and may have a first thermal conductivity. The second region may be adjacent to the flow field plate and may have a second thermal conductivity lower than the first thermal conductivity.

According to another embodiment, a fuel cell is disclosed. The fuel cell may include a gas diffusion layer (GDL) situated between a catalyst layer of the fuel cell and a flow field plate of the fuel cell. The GDL may have a gradient of thermal conductivity between a first region of the GDL and a second region of the GDL along a thickness direction of the fuel cell. The first region may be adjacent to the catalyst layer and have a higher thermal conductivity. The second region may be adjacent to the flow field plate and have a lower thermal conductivity than the higher thermal conductivity.

According to yet another embodiment, a fuel cell is disclosed. The fuel cell may include a gas diffusion layer (GDL) situated between a catalyst layer of the fuel cell and a flow field plate of the fuel cell. The GDL may have a first region and a second region along a thickness direction of the fuel cell. The first region may be adjacent to the catalyst layer and have a uniform thermal conductivity. The second region may be adjacent to the flow field plate and have a gradient of thermal conductivity along the thickness direction of the fuel cell.

### BRIEF DESCRIPTION OF THE DRAWINGS

FIG. 1 depicts a schematic side view of a PEM fuel cell.

FIG. 2 depicts a schematic side view of a half-cell assembly of a PEM fuel cell.

FIG. 3 depicts a schematic diagram showing a location where water is generally condensed in a GDL having a low thermal conductivity.

FIG. 4 depicts a schematic diagram showing a location where water is generally condensed in a GDL having a high thermal conductivity.

FIG. 5 depicts a schematic diagram of a first embodiment of a GDL according to the present disclosure.

FIG. 6 depicts a schematic diagram showing a location where water is generally condensed in a GDL as described in FIG. 5.

FIG. 7 depicts a schematic diagram showing a location where water is generally condensed in a GDL having a reference thermal conductivity.

FIG. 8 depicts a schematic diagram of a second embodiment of a GDL according to the present disclosure.

FIG. 9 depicts a schematic diagram of a third embodiment of a GDL according to the present disclosure.

FIG. 10 depicts a schematic diagram showing a location where water is generally condensed in a GDL as described in FIG. 9.

FIG. 11 depicts a schematic diagram of a fourth embodiment of a GDL according to the present disclosure.

FIG. 12 depicts a schematic diagram of a fifth embodiment of a GDL according to the present disclosure.

FIG. 13 depicts a schematic diagram showing a location where water is generally condensed in a GDL as described in FIG. 12.

FIG. 14 depicts a schematic diagram of a sixth embodiment of a GDL according to the present disclosure.

FIG. 15 depicts a schematic perspective view of a seventh embodiment of a GDL according to the present disclosure.

FIG. 16 depicts a schematic perspective view of an eighth embodiment of a GDL according to the present disclosure.

FIG. 17 depicts a schematic perspective view of a ninth embodiment of a GDL according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for applications or implementations.

This present disclosure is not limited to the specific embodiments and methods described below, as specific components and/or conditions may, of course, vary. Furthermore, the terminology used herein is used only for the purpose of describing embodiments of the present disclosure and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The description of a group or class of materials as suitable for a given purpose in connection with one or more embodiments implies that mixtures of any two or more of the members of the group or class are suitable. Description of constituents in chemical terms refers to the constituents at the time of addition to any combination specified in the description and does not necessarily preclude chemical interactions among constituents of the mixture once mixed.

Except where expressly indicated, all numerical quantities in this description indicating dimensions or material properties are to be understood as modified by the word “about” in describing the broadest scope of the present disclosure.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

The term “substantially” may be used herein to describe disclosed or claimed embodiments. The term “substantially” may modify any value or relative characteristic disclosed or claimed in the present disclosure. “Substantially” may signify that the value or relative characteristic it modifies is within ±0%, 0.1%, 0.5%, 1%, 2%, 3%, 4%, 5% or 10% of the value or relative characteristic.

Reference is being made in detail to compositions, embodiments, and methods of embodiments known to the inventors. However, disclosed embodiments are merely exemplary of the present disclosure which may be embodied in various and alternative forms. Therefore, specific details disclosed herein are not to be interpreted as limiting, rather merely as representative bases for teaching one skilled in the art to variously employ the present disclosure.

Polymer electrolyte membrane (PEM) fuel cells show great potential as an alternative solution for energy production and consumption. Particularly, PEM fuel cells are being developed as electrical power sources for automobile applications. A typical single PEM fuel cell is composed of a PEM, an anode layer, a cathode layer, and gas diffusion layers (GDLs). These components form a membrane electrode assembly (MEA), which is surrounded by two flow field plates.

GDLs are a porous and electrically conductive material composed of a dense array of carbon fibers, which assist with gas and water transport in a PEM fuel cell. Specifically, GDLs provide passages for gas reactants from flow field plates to catalyst layers and for water from the catalyst layers to the flow field plates, thereby facilitating heat and water removal from an MEA and maintaining a healthy operational condition for the PEM fuel cell. In addition, GDLs provide mechanical support to the MEA, and protect the catalyst layers from corrosion. Therefore, the thermal property of GDLs may have major implications on the performance and durability of the PEM fuel cell.

Generally, the thermal conductivity of a GDL in a PEM fuel cell may be in a range of 0.1 and 20 W/mK. A PEM fuel cell equipped with GDLs having a high thermal conductivity may exhibit good fuel cell performance when the PEM fuel cell operates in hot and dry conditions (e.g. when the temperature of the PEM fuel cell is about 80° C., and a relative humidity (RH) level in the PEM fuel cell is about 50%). However, the fuel cell performance may decrease dramatically when such a PEM fuel cell operates in cold and wet conditions (e.g. when the temperature of the PEM fuel cell is about 60° C., and a RH level in the PEM fuel cell is about 90%). On the other hand, a PEM fuel cell equipped with GDLs having a low thermal conductivity may exhibit poor performance when the PEM fuel cell operates in the hot and dry conditions. Such poor performance may be due to an over-dried MEA and deteriorative ionomers in the MEA. Because PEM fuel cells normally operate in a range of dynamic operational conditions, including the hot and dry conditions and the cold and wet conditions, to improve the fuel cell performance and durability, there is a need to incorporate functionalized GDLs that may provide good thermal and water management capabilities into the PEM fuel cell.

Aspects of the present disclosure relate to GDLs of a PEM fuel cell that may provide good thermal and water management capabilities. In a first embodiment, a GDL may include a first region and a second region along a thickness direction of the PEM fuel cell, where the first region has a first thermal conductivity and the second region has a second thermal conductivity lower than the first thermal conductivity. In a second embodiment, a GDL may have a gradient of thermal conductivity along a thickness direction of the PEM fuel cell, where a first region of the GDL is adjacent to a catalyst layer of the PEM fuel cell and has a higher thermal conductivity, and a second region of the GDL is adjacent to a flow field plate of the PEM fuel cell and has a lower thermal conductivity than the higher thermal conductivity. In a third embodiment, a GDL may include a first region and a second region along a thickness direction of the PEM fuel cell, where the first region has a uniform thermal conductivity and the second region has a gradient of thermal conductivity. In some other embodiments, a GDL may further include a third region which has anisotropic thermal conductivity, where the third region may be part of the second region or separated applied to an end region of the second region. In yet some other embodiments, the GDL may not only have a non-uniform thermal conductivity along a thickness direction of the PEM fuel cell but also have a non-uniform thermal conductivity along a length and/or a height direction of the PEM fuel cell.

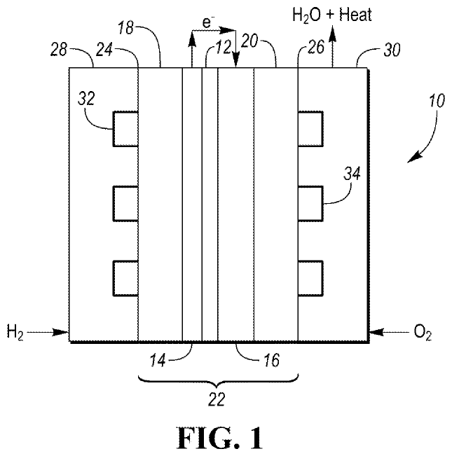

FIG. 1 depicts a schematic side view of a PEM fuel cell. The PEM fuel cell 10 can be stacked to create a fuel cell stack assembly. The PEM fuel cell 10 includes a polymer electrolyte membrane (PEM) 12, an anode layer 14, a cathode layer 16, an anode gas diffusion layer (GDL) 18, and a cathode GDL 20. The PEM 12 is situated between the anode layer 14 and the cathode layer 16. The anode layer 14 is situated between the anode GDL 18 and the PEM 12, and the cathode layer 16 is situated between the cathode GDL 20 and the PEM 12. Further, the PEM 12, the anode 14, the cathode 16, and the anode and cathode GDLs 18 and 20 comprise a membrane electrode assembly (MEA) 22. A catalyst material, such as platinum (Pt), may be included in the anode layer 14 and the cathode layer 16.

A first side 24 of the MEA 22 is bound by an anode flow field plate 28, and the second side 26 of the MEA 22 is bounded by a cathode flow field plate 30. The anode flow field plate 28 includes an anode flow field 32 configured to distribute H₂ to the MEA 22. The cathode flow field plate 30 includes a cathode flow field 34 configured to distribute O₂ to the MEA 22.

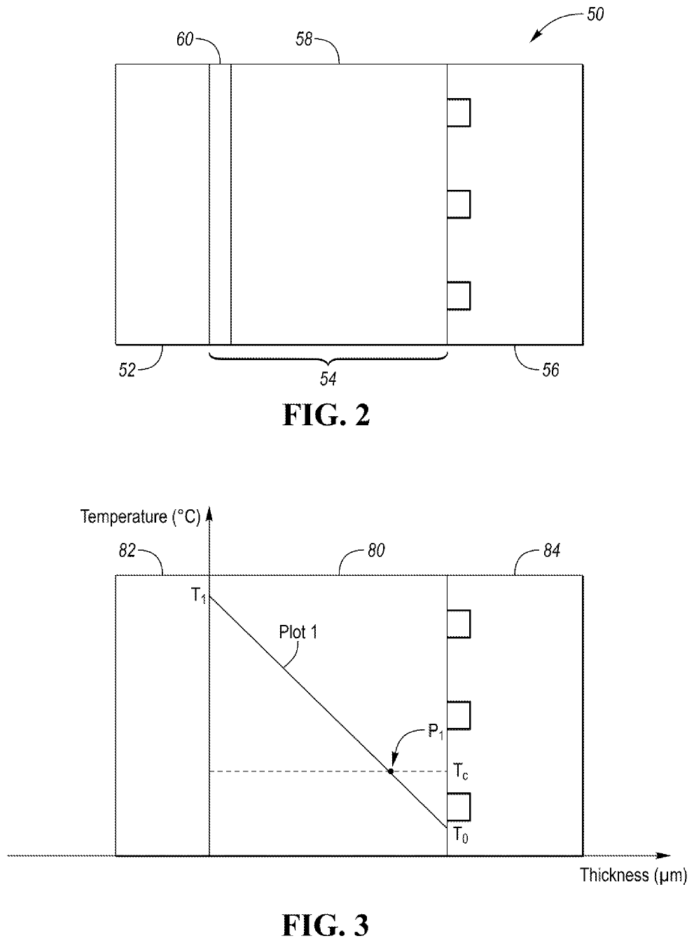

To improve water and gas transport and to enhance electrical contact of a GDL, the GDL may further include a microporous layer (MPL) in contact with a catalyst layer. FIG. 2 depicts a schematic side view of a half-cell assembly of a PEM fuel cell. As shown in FIG. 2, the half-cell assembly 50 includes a catalyst layer 52, a GDL 54, and a flow field plate 56. The GDL 54 is situated between the catalyst layer 52 and the flow field plate 56. In this configuration, the GDL 54 is a dual-layer configuration, which includes a macroporous layer 58 and an MPL 60. The MPL 60 separates the catalyst layer 52 from the macroporous layer 58. Generally, the MPL 60 is composed of carbon black and a hydrophobic agent. The macroporous layer 58 is typically composed of carbon fibers. The MPL 60 may prevent water from blocking the catalyst layer 52, thereby facilitating water and gas transport in the MEA.

FIG. 3 depicts a schematic diagram showing a location where water is generally condensed in a GDL having a low thermal conductivity. Assume that the value of the thermal conductivity of the GDL is R₁. Referring to FIG. 3, T₁ represents the temperature of a first side of the GDL 80 adjacent to a catalyst layer 82. T₀ represents the temperature of a second side of the GDL 80 adjacent to a flow field plate 84, and T₀ is generally the temperature of a coolant that flows in the flow field plate 84 to cool a PEM fuel cell. As depicted in FIG. 3, the temperature of the GDL 80 decreases from the first to the second side of the GDL 80, represented by a Plot 1.

As water is generated in the GDL 80 during a normal operation of the PEM fuel cell, water may also be condensed due to the temperature differences throughout the GDL 80. A water condensation temperature may depend on an operational condition of the PEM fuel cell. As shown in FIG. 3, the water condensation temperature, T_{c}, is between T₁ and T₀, represented by a dotted line. The intersection point of the Plot 1 and the dotted line, P₁, may indicate the location where water is generally condensed in the GDL 80 during or after the normal operation of the PEM fuel cell. Referring to FIG. 3, the water condensation location P₁ appears to be closer to the flow field plate 84 compared to the catalyst layer 82. Such a water condensation location may make the condensed water less likely flood the entire GDL 80. However, due to the low thermal conductivity of the GDL 80, T₁ is usually high. Such a high temperature of T₁ may accelerate the degradation of the MEA.

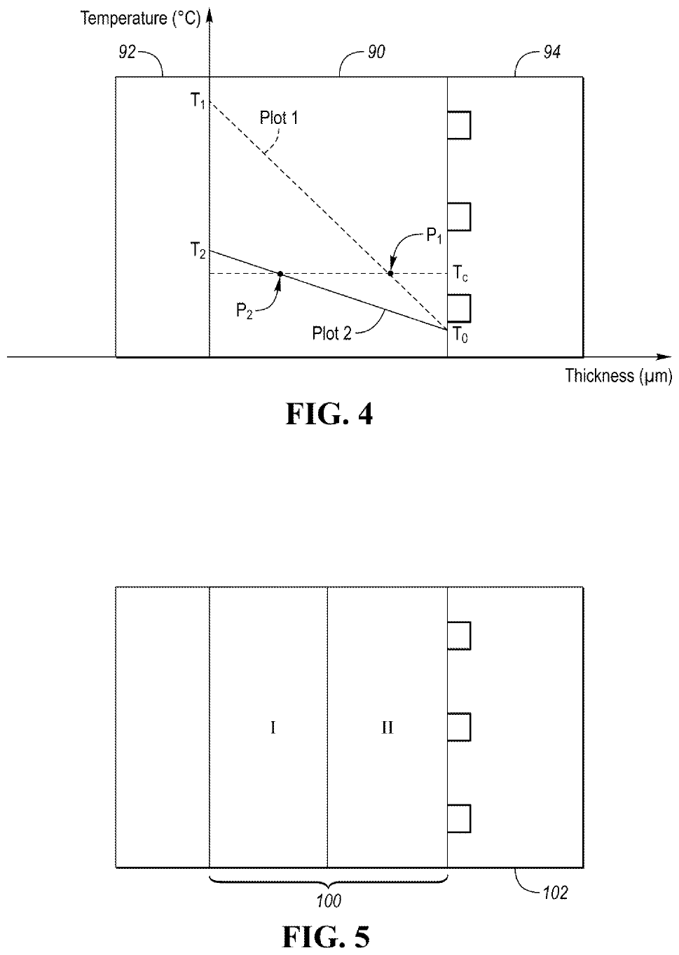

FIG. 4 depicts a schematic diagram showing a location where water is generally condensed in a GDL having a high thermal conductivity. Assume that the value of the thermal conductivity of the GDL is R₂, where R₂>R₁. Referring to FIG. 4, T₂ represents the temperature of a first side of the GDL 90 adjacent to a catalyst layer 92. To represents the temperature of a second side of the GDL 90 adjacent to a flow field plate 94, and T₀ is generally the temperature of a coolant that flows in the flow field plate 94 to cool a PEM fuel cell. As depicted in FIG. 4, the temperature of the GDL 90 decreases from the first to the second side of the GDL 90, represented by a Plot 2. The Plot 1 from FIG. 3 is incorporated in FIG. 4 for comparison.

Assume that the PEM fuel cell in FIG. 4 operates in a similar condition as that in FIG. 3, then the dotted line represents the water condensation temperature T_{c} in the GDL 90 as that in the GDL 80 in FIG. 3. Further assume that the coolant temperature T₀ is also the same as that in FIG. 3, then the intersection point of the Plot 2 and the dotted line, P₂, may indicate the location where water is generally condensed in the GDL 90. Comparing with the water condensation location P₁ in the GDL 80 of FIG. 3, the water condensation location P₂ in the GDL 90 appears to be closer to the catalyst layer 92. Although T₂ is lower than T₁, such a water condensation location of P₂ may, however, induce an adverse effect on the catalyst performance in the catalyst layer 92 (e.g. when the PEM fuel cell operates in wet conditions), thereby decreasing the durability of the PEM fuel cell.

In view of FIGS. 3 and 4, results indicate that when a GDL has a lower thermal conductivity, a water condensation location in the GDL may be relatively closer to a flow field plate (i.e. away from a catalyst layer), but the temperature of the GDL is generally high. This may result in the drying of the PEM and the catalyst layers of a PEM fuel cell, thereby sacrificing the fuel cell performance, especially when the PEM fuel cell operates in dry conditions. On the other hand, when a GDL has a higher thermal conductivity, a water condensation location in the GDL may be relatively closer to a catalyst layer, and the condensed water in the GDL may be more likely to block catalysts in the catalyst layer, thereby deteriorating the catalyst performance, especially when the PEM fuel cell operates in wet conditions. Therefore, to improve the performance and durability of a PEM fuel cell, there is a need to have a GDL which can afford a better thermal and water management capability in either the dry or wet conditions.

FIG. 5 depicts a schematic diagram of a first embodiment of a GDL according to the present disclosure. As shown in FIG. 5, the GDL 100 includes two regions, region I and region II. Particularly, region I may have a higher thermal conductivity, for example, R_{I}, and region II may have a lower thermal conductivity, for example, R_{II}, where R_{I}>R_{II}. As such, the GDL 100 has two different thermal conductivities along a thickness direction of a PEM fuel cell.

A total thickness of the GDL 100 may be in a range of 20 and 400 μm. Particularly, the thickness of region II may be in a range of 20 and 150 μm. Although regions I and II appear to be equal or substantially equal in thickness in FIG. 5, their thicknesses may vary based on an operational condition of the PEM fuel cell. Additionally, the thickness of region II may further be influenced by the temperature of the coolant (i.e. T₀) that flows in a flow field plate 102. When a low thermal conductivity is needed, the thickness of region II may be small.

As to the compositions of the GDL 100, region I may be composed of a high thermal conductivity material. Non-limiting examples of the high thermal conductivity material may include graphite, graphene, carbon nanotubes, or a combination thereof. On the other hand, region II may be composed of a low thermal conductivity material, such as carbon fibers. To produce the GDL 100, regions I and II may be laminated. Additionally, region I may be cladded onto region II, or vice versa.

Referring to FIG. 5, although the GDL 100 appears to include two regions with different thermal conductivities, the GDL 100 may, however, include more than two regions, where the thermal conductivity of each of the more than two regions may vary along a thickness direction of the PEM fuel cell.

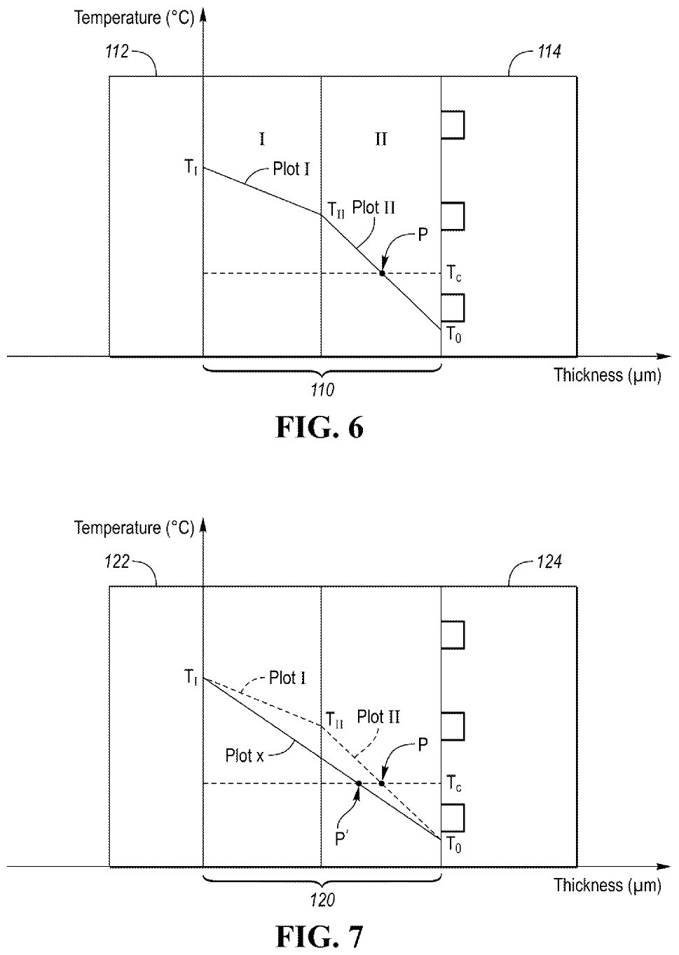

FIG. 6 depicts a schematic diagram showing a location where water is generally condensed in a GDL as described in FIG. 5. As shown in FIG. 6, the GDL 110 includes two regions along a thickness direction of a PEM fuel cell, region I and region II. Particularly, region I may have a higher thermal conductivity, for example, R_{I}, and region II may have a lower thermal conductivity, for example, R_{II}, where R_{I}>R_{II}. Referring to FIG. 6, T₁ represents the temperature of a first side of the GDL 110 adjacent to a catalyst layer 112. T_{II} represents the temperature of a middle area of the GDL 110 where region I meets region II. As depicted in FIG. 6, the temperature of the GDL 110 in region I decreases from the first side to the middle area of the GDL 110, represented by a Plot I. Additionally, To represents the temperature of a second side of the GDL 110 adjacent to a flow field plate 114, and T₀ is generally the temperature of a coolant that flows in the flow field plate 114 to cool the PEM fuel cell. As shown in FIG. 6, the temperature of the GDL 110 in region II decreases from the middle area to the second side of the GDL 110, represented by a Plot II.

Assume that the PEM fuel cell in FIG. 6 operates in a similar condition as those in FIGS. 3 and 4, then the dotted line still represents the water condensation temperature T_{c} in the GDL 110 as that in the GDL 80 or 90 in FIG. 3 or 4, respectively. Further assume that the coolant temperature T₀ is also the same as that in FIG. 3 or 4, then the intersection point of the Plot II and the dotted line, P, may indicate the location where water is generally condensed in the GDL 110.

FIG. 7 depicts a schematic diagram showing a location where water is generally condensed in a GDL that has a reference thermal conductivity. The reference thermal conductivity is introduced here for comparison. As shown in FIG. 7, the reference thermal conductivity allows a GDL 120 to have the same or substantially the same T₁ at a first side of the GDL 120 as that of the GDL 110 in FIG. 6. The first side of the GDL 120 is adjacent to a catalyst layer 122. To still represents the temperature of a second side of the GDL 120 adjacent to a flow field plate 124, and T₀ is generally the temperature of a coolant that flows in the flow field plate 124 to cool a PEM fuel cell. As depicted in FIG. 7, the temperature of the GDL 120 decreases from the first to the second side of the GDL 120, represented by a Plot x. The Plots I and II from FIG. 6 are incorporated in FIG. 7 for comparison.

The PEM fuel cell in FIG. 7 may operate in a similar condition as that in FIG. 6. In such case, the dotted line represents the water condensation temperature T_{c} in the GDL 120 as that in the GDL 110 in FIG. 6. Further, the coolant temperature T₀ may also be the same as that in FIG. 6. In such case, the intersection point of the Plot x and the dotted line, P′, may indicate the location where water is generally condensed in the GDL 120. Comparing with the water condensation location Pin the GDL 110 of FIG. 6, the water condensation location P′ in the GDL 120 appears to be closer to the catalyst layer 122, which, as illustrated above, is not favorable.

In view of FIGS. 6 and 7, the water condensation location in a GDL may be shifted toward a flow field plate (i.e. away from a catalyst layer) when the GDL includes a non-uniform thermal conductivity along a thickness direction of a PEM fuel cell. As discussed above, when a water condensation location is farther away from a catalyst layer, the condensed water would be less likely to have an adverse impact on the catalyst performance in the catalyst layer. Therefore, when a PEM fuel cell incorporates a GDL that has a non-uniform thermal conductivity along a thickness direction of the PEM fuel cell, the fuel cell performance and the durability of the PEM fuel cell may be improved.

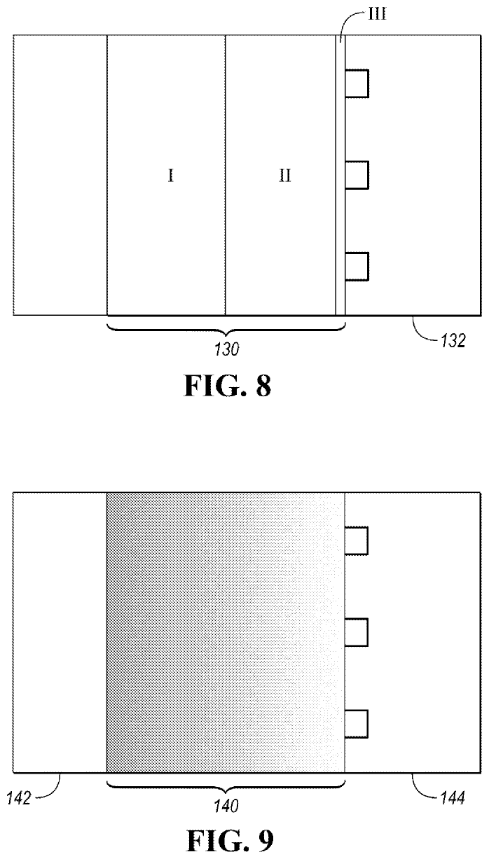

FIG. 8 depicts a schematic diagram of a second embodiment of a GDL according to the present disclosure. As shown in FIG. 8, the GDL 130 includes three regions along a thickness direction of a PEM fuel cell, region I, region II, and region III. Particularly, region I may have a first thermal conductivity, for example, R_{I}, and region II may have a second thermal conductivity, for example, R_{II}, where R_{I}>R_{II}. Referring to FIG. 8, region III is situated adjacent to a flow field plate 132 of a PEM fuel cell. In this embodiment, region III is anisotropic, where the thermal conductivity of region III may be different in different directions. For example, the thermal conductivity of region III in a cross-plane direction may be the same as or lower than R_{II}, whereas the thermal conductivity of region III in an in-plane direction is higher than R_{II}. In one or more embodiments, region III may be an end region of region II. In some other embodiments, region III may be applied separately to an end region of region II and situated between region II and the flow field plate 132. Incorporating region III in the GDL 130 may further help increase the GDL performance and subsequently improve the durability of the PEM fuel cell.

FIG. 9 depicts a schematic diagram of a third embodiment of a GDL according to the present disclosure. Referring to FIG. 9, the GDL 140 may have a gradient of thermal conductivity along a thickness direction of a PEM fuel cell. Specifically, a first side of the GDL 140 is adjacent to a catalyst layer 142 of the PEM fuel cell, and the second side of the GDL 140 is adjacent to a flow field plate 144 of the PEM fuel cell. In addition, the first side may have a higher thermal conductivity, and the second side may have a lower thermal conductivity than the higher thermal conductivity. The thermal conductivity of the GDL 140 gradually decreases from the first to the second side of the GDL 140.

A total thickness of the GDL 140 may be in a range of 20 and 400 μm. The thermal conductivity of the GDL 140 may be in a range of 0.1 and 20 W/mK. To produce the GDL 140, high thermal conductivity materials, such as graphite, graphene, carbon nanotubes, or a combination thereof, may be infiltrated into the porous structure of low thermal conductivity materials, such as carbon fibers, using an infiltration method.

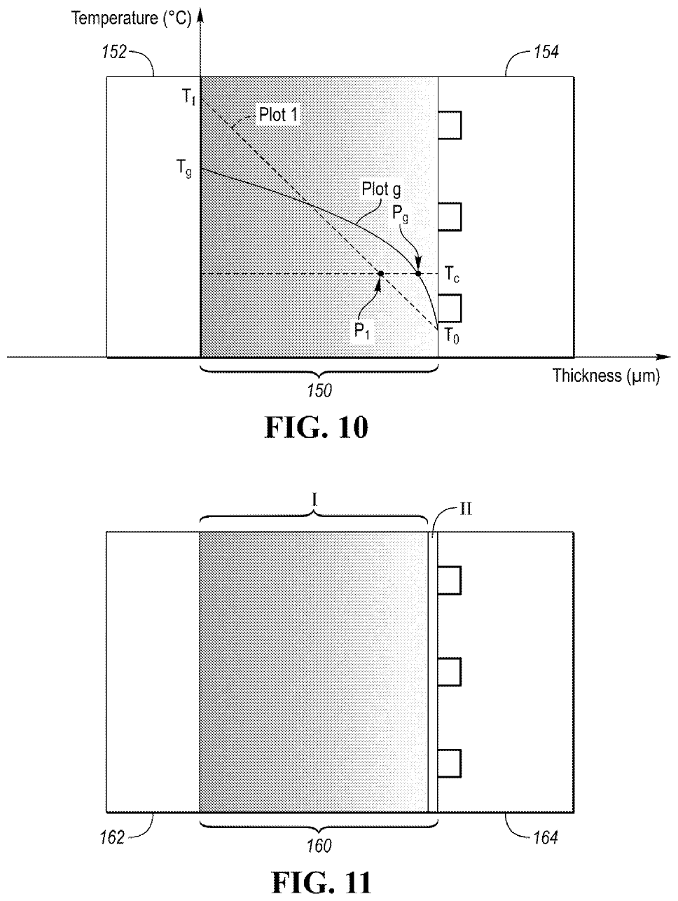

FIG. 10 depicts a schematic diagram showing a location where water is generally condensed in a GDL as described in FIG. 9. As shown in FIG. 10, the GDL 150 has a gradient of thermal conductivity from a first side of the GDL 150 adjacent to a catalyst layer 152 to a second side of the GDL 150 adjacent to a flow field plate 154, where the first side has a higher thermal conductivity and the second side has a lower thermal conductivity than the higher thermal conductivity. Referring to FIG. 10, T g represents the temperature of the first side of the GDL 150. To represents the temperature of the second side of the GDL 150, and T₀ is generally the temperature of a coolant that flows in the flow field plate 154 to cool a PEM fuel cell. As depicted in FIG. 10, the temperature of the GDL 150 decreases from the first to the second side of the GDL 150, represented by a Plot g. The Plot 1 from FIG. 3 is incorporated FIG. 10 for comparison.

The PEM fuel cell in FIG. 10 may operate in a similar condition as that in FIG. 3. In such case, the dotted line represents the water condensation temperature T_{c} in the GDL 150 as that in the GDL 80 in FIG. 3. The coolant temperature T₀ may also be the same as that in FIG. 3. In such case, the intersection point of the Plot g and the dotted line, P_{g}, may indicate the location where water is generally condensed in the GDL 150. Comparing with the water condensation location P₁ in the GDL 80 of FIG. 3, the water condensation location P_{g} in the GDL 150 is shown to be closer to the flow field plate 154 (i.e. away from the catalyst layer 152). In view of FIGS. 3 and 10, when a GDL has a gradient of thermal conductivity, the water condensation location in the GDL may be shifted toward a flow field plate (i.e. away from a catalyst layer). Such a water condensation location may, therefore, reduce a potential adverse effect the condensed water may impose upon the catalysts in the catalyst layer, and ultimately, enhance the performance and the durability of a PEM fuel cell.

FIG. 11 depicts a schematic diagram of a fourth embodiment of a GDL according to the present disclosure. Referring to FIG. 9, the GDL 160 includes two regions along a thickness direction of a PEM fuel cell, region I and region II. Particularly, region I has a gradient of thermal conductivity along a thickness direction of a PEM fuel cell. A first side of region I is adjacent to a catalyst layer 162 of the PEM fuel cell, and the second side of region I is adjacent to region II. The first side of region I may have a first thermal conductivity, for example, R_{I}, and the second side of region I may have a second thermal conductivity, for example, R_{II}, where R_{I}>R_{II}. The thermal conductivity of region I gradually decreases from the first to the second side of region I. Region II is situated adjacent to a flow field plate 164 of the PEM fuel cell. In this embodiment, region II is anisotropic, where the thermal conductivity of region II may be different in different directions. For example, the thermal conductivity of region II in a cross-plane direction may gradually decrease from the value of R_{II}, whereas the thermal conductivity of region II in an in-plane direction may be higher than R_{II}. In one or more embodiments, region II may be an end region of region I. In some other embodiments, region II may be applied separately to an end region of region I and situated between region I and the flow field plate 164. Incorporating region II in the GDL 160 may further help increase the GDL performance and subsequently improve the durability of the PEM fuel cell.

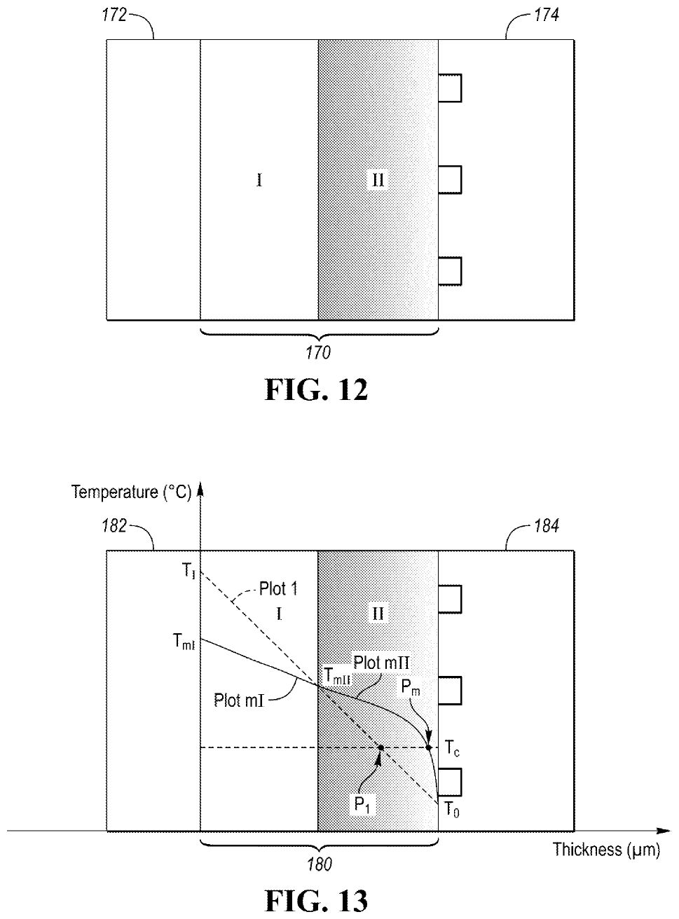

FIG. 12 depicts a schematic diagram of a fifth embodiment of a GDL according to the present disclosure. As shown in FIG. 12, the GDL 170 includes two regions along a thickness direction thereof, region I and region II. Particularly, region I has a uniform thermal conductivity, and region II has a gradient of thermal conductivity from a first side of the region II (i.e. where region II meets region I) to a second side of the region II adjacent to a flow field plate 174 (i.e. also where the GDL 170 is adjacent to the flow field plate 174).

A total thickness of the GDL 170 may be in a range of 20 and 400 μm. Although regions I and II appear to be equal or substantially equal in thickness in FIG. 12, their thicknesses may vary based on an operational condition of the PEM fuel cell.

As to the compositions of the GDL 170, region I may be composed of a high thermal conductivity material. Non-limiting examples of the high thermal conductivity material may include graphite, graphene, carbon nanotubes, or a combination thereof. In addition, region II may be formed by an infiltration method, where high thermal conductivity materials, such as graphite, graphene, carbon nanotubes, or a combination thereof, may be infiltrated into the porous structure of low thermal conductivity materials, such as carbon fibers, to form a high thermal conductivity layer.

FIG. 13 depicts a schematic diagram showing a location where water is generally condensed in a GDL as described in FIG. 12. As shown in FIG. 13, the GDL 180 includes two regions along a thickness direction of a PEM fuel cell, region I and region II. Particularly, region I of the GDL 180 may have a first thermal conductivity, and region II of the GDL 180 may have a gradient of thermal conductivity. Referring to FIG. 13, T_{mI} represents the temperature of a first side of the GDL 180 adjacent to a catalyst layer 182. Time represents the temperature of a middle area of the GDL 180 where region I meets region II. As depicted in FIG. 13, the temperature of the GDL 180 in region I decreases from the first side to the middle area of the GDL 180, represented by a Plot mI. Additionally, To represents the temperature of a second side of the GDL 180 (i.e. also the second side of the region II) adjacent to a flow field plate 184, and T₀ is generally the temperature of a coolant that flows in the flow field plate 184 to cool the PEM fuel cell. As shown in FIG. 13, the temperature of the GDL 180 in region II decreases from the middle area to the second side of the GDL 180, represented by a Plot mII. The Plot 1 from FIG. 3 is incorporated in FIG. 13 for comparison. In this embodiment, the first thermal conductivity in region I and the gradient of thermal conductivity in region II are selected such that T_{mII} is consistent or substantially consistent in both the Plots mI and mII.

The PEM fuel cell in FIG. 13 may operate in a similar condition as that in FIG. 3. In such case, the dotted line represents the water condensation temperature T_{c} in the GDL 180 as that in the GDL 80 in FIG. 3. The coolant temperature T₀ may also be the same as that in FIG. 3. In such case, the intersection point of the Plot mII and the dotted line, Pₘ, may indicate the location where water is generally condensed in the GDL 180. In view of FIGS. 3 and 13, when one region of a GDL adjacent to a catalyst layer has a uniform thermal conductivity and the other region of the GDL adjacent to a flow field plate has a gradient of thermal conductivity, a water condensation location in the GDL may be shifted toward the flow field plate (i.e. away from the catalyst layer). Such a water condensation location may, therefore, reduce a potential adverse effect the condensed water may impose upon the catalysts in the catalyst layer, and ultimately, improve the performance and the durability of a PEM fuel cell.

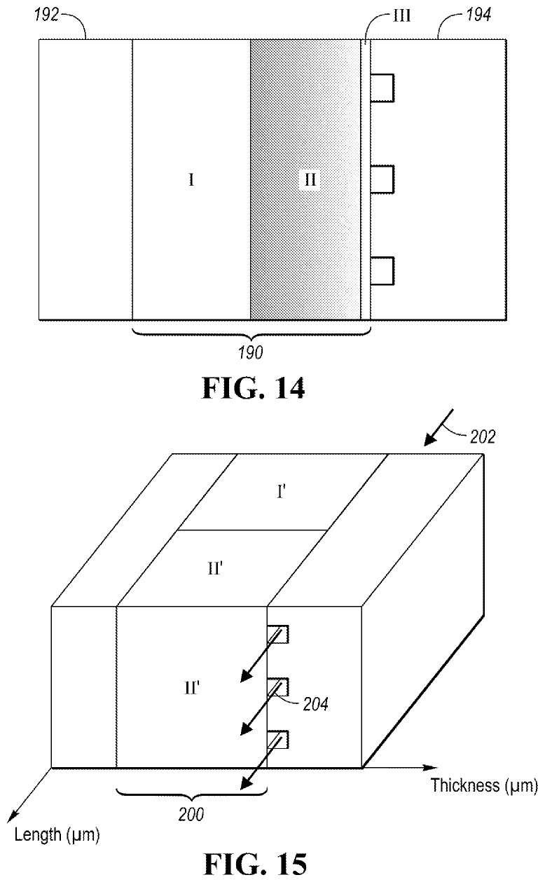

FIG. 14 depicts a schematic diagram of a sixth embodiment of a GDL according to the present disclosure. As shown in FIG. 14, the GDL 190 includes three regions along a thickness direction thereof, region I, region II, and region III. Particularly, region I has a uniform thermal conductivity, for example, R_{II}, and region II has a gradient of thermal conductivity from a first side of region II (i.e. where region II meets region I) to a second side of the region II (i.e. where region II meets region III). The first side of region II may have a first thermal conductivity, for example, R_{I}, where R_{I} may be the same or substantially the same as R_{II}. The second side of region II may have a second thermal conductivity, for example, R_{II}, where R_{I}>R_{II}. Region III is situated adjacent to a flow field plate 194 of the PEM fuel cell. In this embodiment, region III is anisotropic, where the thermal conductivity of region III may be different in different directions. For example, the thermal conductivity of region III in a cross-plane direction may gradually decrease from the value R_{II}, whereas the thermal conductivity of region III in an in-plane direction may be higher than R_{II}. In one or more embodiments, region III may be an end region of region II. In some other embodiments, region III may be applied separately to an end region of region II and situated between region II and the flow field plate 194. Incorporating region III in the GDL 190 may further help increase the GDL performance and subsequently improve the durability of the PEM fuel cell.

Apart from varying the thermal conductivity of a GDL along a thickness direction of a PEM fuel cell, the thermal conductivity of the GDL may also be modified along a length direction of the PEM fuel cell. FIG. 15 depicts a schematic perspective view of a seventh embodiment of a GDL according to the present disclosure. As shown in FIG. 15, a PEM fuel cell has a reactant inlet 202 and a reactant outlet 204. In addition, the GDL 200 includes two regions along a length direction of the PEM fuel cell, region I′ and region II′. Particularly, region I′ is closer to the reactant inlet 202. During a normal operation of the PEM fuel cell, a higher amount of a reactant (e.g. air or O₂) may pass through region I′. Accordingly, the reactivity in region I′ may be relatively higher than that in region II′, and region I′ may have a relatively higher temperature than region II′. In this embodiment, to improve the thermal and water management in the GDL 200, region I′ may have a higher thermal conductivity, for example, R_{I′}, and region II may have a lower thermal conductivity, for example, R_{II′}, where R_{I′}>R_{II′}. As such, the GDL 200 has two different thermal conductivities along the length direction of the PEM fuel cell.

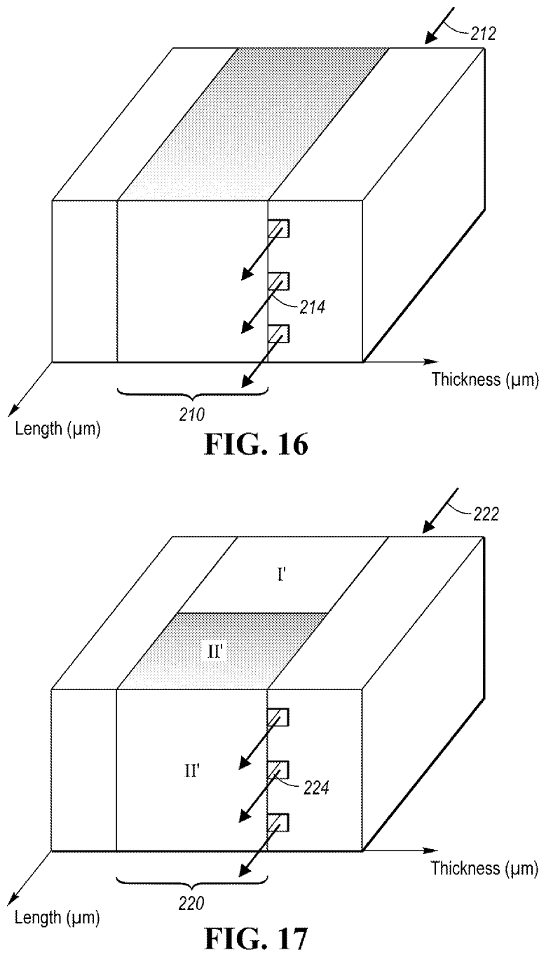

FIG. 16 depicts a schematic perspective view of an eighth embodiment of a GDL according to the present disclosure. Referring to FIG. 16, a PEM fuel cell has a reactant inlet 212 and a reactant outlet 214. As discussed in FIG. 16, the area of the GDL 210 adjacent to the reactant inlet 212 may have a higher reactivity and accordingly, a higher temperature than the area of the GDL 210 adjacent to the reactant outlet 214. In this embodiment, to improve the thermal and water management in the GDL 210, The GDL 210 may have a gradient of thermal conductivity along the length direction of the PEM fuel cell.

FIG. 17 depicts a schematic perspective view of a ninth embodiment of a GDL according to the present disclosure. Referring to FIG. 17, a PEM fuel cell has a reactant inlet 222 and a reactant outlet 224. The GDL 220 includes two regions along a length direction of the PEM fuel cell, region I′ and region II′. As discussed in FIGS. 15 and 16, because region I′, being adjacent to the reactant inlet 222, may have a higher reactivity and a higher temperature than region II′, using the logic of the fifth embodiment of the GDL 170 illustrated in FIG. 12, to further improve the thermal and water management in the GDL 220, region I′ may have a uniform thermal conductivity, and region II′ may have a gradient of thermal conductivity along the length direction of the PEM fuel cell.

The embodiments described above are related to scenarios where the thermal conductivity of a GDL is either varied in a thickness direction or a length direction of a PEM fuel cell. However, in other embodiments, not only does the GDL vary the thermal conductivity along the thickness direction of a PEM fuel cell, but it also varies the thermal conductivity along the length direction of the PEM fuel cell.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A fuel cell comprising:
a gas diffusion layer (GDL) situated between a catalyst layer of the fuel cell and a flow field plate of the fuel cell, the GDL having a first region and a second region along a thickness direction of the fuel cell, the first region being adjacent to the catalyst layer and having a first thermal conductivity, the second region being adjacent to the flow field plate and having a second thermal conductivity lower than the first thermal conductivity.

2. The fuel cell of claim 1, wherein the first region of the GDL includes graphite, graphene, carbon nanotubes, or a combination thereof.

3. The fuel cell of claim 1, wherein the second region of the GDL includes carbon fibers.

4. The fuel cell of claim 1, wherein the first thermal conductivity is in a range of 0.1 and 20 W/mK, and the second thermal conductivity is in a range of 0.1 and 20 W/mK.

5. The fuel cell of claim 1, wherein the second region further comprises a third region adjacent to the flow field plate, and the third region has anisotropic thermal conductivities.

6. The fuel cell of claim 1, wherein a third region is situated between the second region and the flow field plate, and the third region has anisotropic thermal conductivities.

7. A fuel cell comprising:
a gas diffusion layer (GDL) situated between a catalyst layer of the fuel cell and a flow field plate of the fuel cell, the GDL having a gradient of thermal conductivity between a first region of the GDL and a second region of the GDL along a thickness direction of the fuel cell, the first region being adjacent to the catalyst layer and having a higher thermal conductivity, the second region being adjacent to the flow field plate and having a lower thermal conductivity than the higher thermal conductivity.

8. The fuel cell of claim 7, wherein the GDL includes a mixture of a first material and a second material, the first material having a first thermal conductivity, the second material having a second thermal conductivity lower than the first thermal conductivity.

9. The fuel cell of claim 8, wherein the first material includes graphite, graphene, carbon nanotubes, or a combination thereof.

10. The fuel cell of claim 8, wherein the second material includes carbon fibers.

11. The fuel cell of claim 7, wherein the gradient of thermal conductivity is in a range of 0.1 and 20 W/mK.

12. The fuel cell of claim 7, wherein the second region further comprises a third region adjacent to the flow field plate, and the third region has anisotropic thermal conductivities.

13. The fuel cell of claim 7, wherein a third region is situated between the second region and the flow field plate, and the third region has anisotropic thermal conductivities.

14. A fuel cell comprising:
a gas diffusion layer (GDL) situated between a catalyst layer of the fuel cell and a flow field plate of the fuel cell, the GDL having a first region and a second region along a thickness direction of the fuel cell, the first region being adjacent to the catalyst layer and having a uniform thermal conductivity, the second region being adjacent to the flow field plate and having a gradient of thermal conductivity along the thickness direction of the fuel cell.

15. The fuel cell of claim 14, wherein the first region of the GDL includes graphite, graphene, carbon nanotubes, or a combination thereof.

16. The fuel cell of claim 14, wherein the second region of the GDL includes a mixture of a first material and a second material.

17. The fuel cell of claim 16, wherein the first material includes graphite, graphene, carbon nanotubes, or a combination thereof, and the second material includes carbon fibers.

18. The fuel cell of claim 14, wherein the uniform thermal conductivity is in a range of 0.1 and 20 W/mK, and the gradient of thermal conductivity is in a range of 0.1 and 20 W/mK.

19. The fuel cell of claim 14, wherein the second region further comprises a third region adjacent to the flow field plate, and the third region has anisotropic thermal conductivities.

20. The fuel cell of claim 14, wherein a third region is situated between the second region and the flow field plate, and the third region has anisotropic thermal conductivities.
